(19) United States
(12) Patent Application Publication
(10) Pub. No.: US 2014/0334773 A1
(43) Pub. Date: Nov. 13, 2014

(54) APPARATUS FOR USE IN OPTOELECTRONICS

(71) Applicants: Sagi Varghese Mathai, Berkeley, CA (US); Michael Renne Ty Tan, Menlo Park, CA (US); Paul Kessier Rosenberg, Sunnyvale, CA (US); Wayne Victor Sorin, Mountain View, CA (US)

(72) Inventors: Sagi Varghese Mathai, Berkeley, CA (US); Michael Renne Ty Tan, Menlo Park, CA (US); Paul Kessier Rosenberg, Sunnyvale, CA (US); Wayne Victor Sorin, Mountain View, CA (US)

(21) Appl. No.: 14/371,509

(22) PCT Filed: Jan. 31, 2012
(86) PCT No.: PCT/US2012/023384

§ 371 Date: Jul. 10, 2014

(51) Int. Cl. G02B 6/42; G02B 6/13

(52) U.S. Cl. CPC G02B 6/4228; G02B 6/4202; G02B 6/13; G02B 6/4239; G02B 6/4244; G02B 6/4245; G02B 6/4238
USPC 385/14; 438/27; 438/65; 438/25

(57) ABSTRACT

An apparatus for use in optoelectronics includes a first alignment element and a first wafer comprising a through optical via. The first alignment element is bonded to the first wafer, such that the through optical via is uncovered by the first alignment element. In addition, the first wafer further comprises a plurality of bond pads upon which an optoelectronic component having an optical element is to be attached, in which the first alignment element is to mate with a mating alignment element on an optical transmission medium, and wherein the optical transmission medium is to be passively aligned with the optical element through the through optical via when the first alignment element is mated with the mating alignment element on the optical transmission medium.

### BACKGROUND

Optical engines are commonly used to transfer electronic data at high rates of speed. An optical engine includes hardware for converting electrical signals to optical signals. The hardware may include a light source, such as a laser device, that outputs light into an optical transmission medium, such as a waveguide or fiber optic cable, which transports the optical signals to a destination. Accurate alignment between the light source and the optical transmission medium is required to enable effective communication of the optical signals from the light source to the optical transmission medium.

Conventionally, light sources are coupled to optical transmission media through a process known as active alignment. Active alignment typically involves energizing a light source and using a lens system to direct light from a light source into an optical transmission medium. Active alignment utilizes a feedback signal to adjust the physical location of key components. As such, active alignment is known to be tedious, time consuming, and costly.

### BRIEF DESCRIPTION OF THE DRAWINGS

Elements of the present disclosure are illustrated by way of example and not limited in the following figure(s), in which like numerals indicate like elements, in which:

FIG. 1 shows a cross-sectional side view of an optoelectronic system, according to an example of the present disclosure;

FIG. 2 shows a partially exploded cross-sectional side view of an apparatus for use in the optoelectronic system depicted in FIG. 1, according to another example of the present disclosure;

FIG. 3 shows a top view of an optoelectronic array of a plurality of apparatus depicted in FIGS. 1 and 2, according to an example of the present disclosure;

FIG. 4 depicts a portion of the optoelectronic system depicted in FIG. 1, according to an example of the present disclosure;

FIG. 5 depicts various examples of different shapes of the first alignment element, according to an example of the present disclosure;

FIGS. 6A and 6B, respectively, depict different shapes and types of through optical vias, according to an example of the present disclosure; and

FIG. 7 shows a flow diagram of a method for fabricating an apparatus to passively align an optical element in an optoelectronic component to an optical transmission medium, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on. In addition, the term “optoelectronic component” refers to an optical source device, such as, a laser, an optical receiver device, such as, a detector, an optical modulator, such as an electro-optic modulator, or a combination of an optical source device and/or a modulator, and an optical receiver device, such as, a transceiver. Moreover, the term “optical element” refers to the actual part of the optoelectronic component that emits and/or senses light. Furthermore, the term “light” refers to electromagnetic radiation with wavelengths in the visible and non-visible portions of the electromagnetic spectrum, including infrared and ultra-violet portions of the electromagnetic spectrum.

Disclosed herein are an apparatus for use in optoelectronics, a method for fabricating the apparatus, and an optoelectronic (OE) system. The apparatus includes a through optical via (TOV) and bond pads, in which, the bond pads are precisely aligned with the TOV such that an optical element of an OE component is aligned with the TOV when the OE component is attached to the bond pads. In addition, the apparatus includes an alignment element that is to mate with a mating alignment element on an optical element, such that, mating of the alignment elements causes an optical fiber in the optical transmission medium to precisely align with the TOV. In this regard, the optical element may be passively aligned with the optical fiber.

Passive alignment is generally simpler and less costly to implement than active alignment, which is discussed above. In one regard, passive alignment does not require energizing the optoelectronic component when coupling the optical transmission medium to the optoelectronic component.

Through use of the apparatus, method, and system described herein, optoelectronic components, such as source devices, receiving devices, and transceiver devices, may effectively be coupled to an optical transmission medium without the use of active alignment systems and techniques. Thus, the coupling may be achieved efficiently at a lower cost. Additionally, more optical connections may be fit into a smaller space, thus providing a more efficient use of chip space.

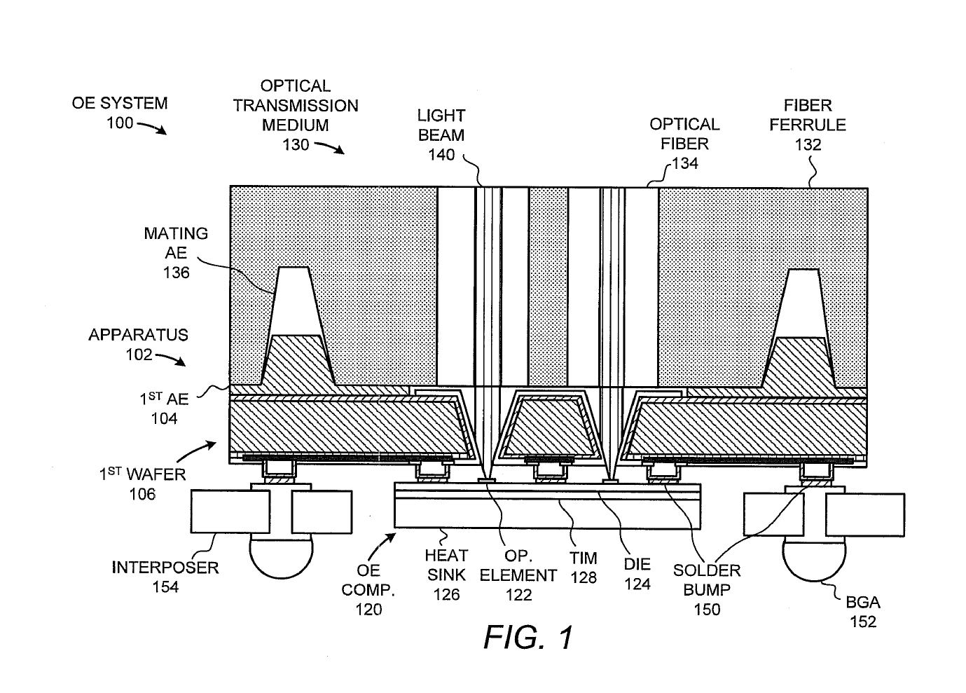

FIG. 1 shows a cross-sectional side view of an optoelectronic (OE) system 100, according to an example. It should be understood that the OE system 100 depicted in FIG. 1 may include additional components and that some of the components described herein may be removed and/or modified without departing from a scope of the OE system 100. It should also be understood that the components depicted in FIG. 1 are not drawn to scale and thus, the components may have different relative sizes with respect to each other than as shown therein.

The OE system 100 is depicted as including an apparatus 102, an OE component (comp.) 120, an optical transmission medium 130, a ball grid array (BGA) 152, and an interposer 154. The OE component 120 is depicted as including an optical (op.) element 122 positioned on a die 124, a heat sink 126, and a thermal interface material (TIM) 128 positioned between the die 124 and the heat sink 126. As shown in FIG. 1, and according to an example, the optical element 122 generates a light beam 140, which may comprise a laser beam. In this example, the die 124 may comprise a laser source, such as, a vertical-cavity surface-emitting laser (VCSEL), a light emitting diode (LED), etc. In another example, the optical element 122 receives a light beam 140. In this example, the die 124 may comprise an optical receiver, such as a photodetector. In another example, the optical element 122 may be a combination light source and external modulator, such as an electro-optic modulator.

The optical transmission medium 130 is depicted as comprising a fiber ferrule 132, optical fibers 134, and a mating alignment element (MAE) 136. The fiber ferrule 132 generally protects the optical fibers 134 and contains the mating alignment element 136. The optical fibers 134 may comprise any suitable media through which light beams may be transmitted.

Although the mating alignment element 136 has been depicted as comprising a hole, it should be understood that the mating alignment element 136 may comprise any other suitable configuration that is suitable for mating with a mating element of the apparatus 102. In this regard, the configuration of the mating alignment element 136 may be selected such that the mating alignment element 136 mates with a first mating alignment element 104 of the apparatus 102. In addition, although the mating alignment element 136 has been depicted as being integrally formed into the fiber ferrule 132, the mating alignment element 136 may alternatively be formed in a separate element that is attached to the optical transmission medium 130.

Generally speaking, the apparatus 102 operates as an interface between the OE component 120 and the optical transmission medium 130. More particularly, the apparatus 102 operates to passively align the OE component 120 with the optical transmission medium 130, such that light beams 140 emitted and/or received by the optical element(s) 122 on the OE component 120 are substantially precisely aligned with the optical fiber(s) 134 in the optical transmission medium 130. The alignment of the OE component 120 and the optical transmission medium 130 is passive because the alignment occurs when the mating alignment element 136 of the optical transmission medium 130 mates with the first mating alignment element 104 of the apparatus 102. In this regard, and in contrast with active alignment techniques, the passive alignment techniques disclosed herein generally require less time and effort and are thus less expensive to implement as compared with active alignment techniques.

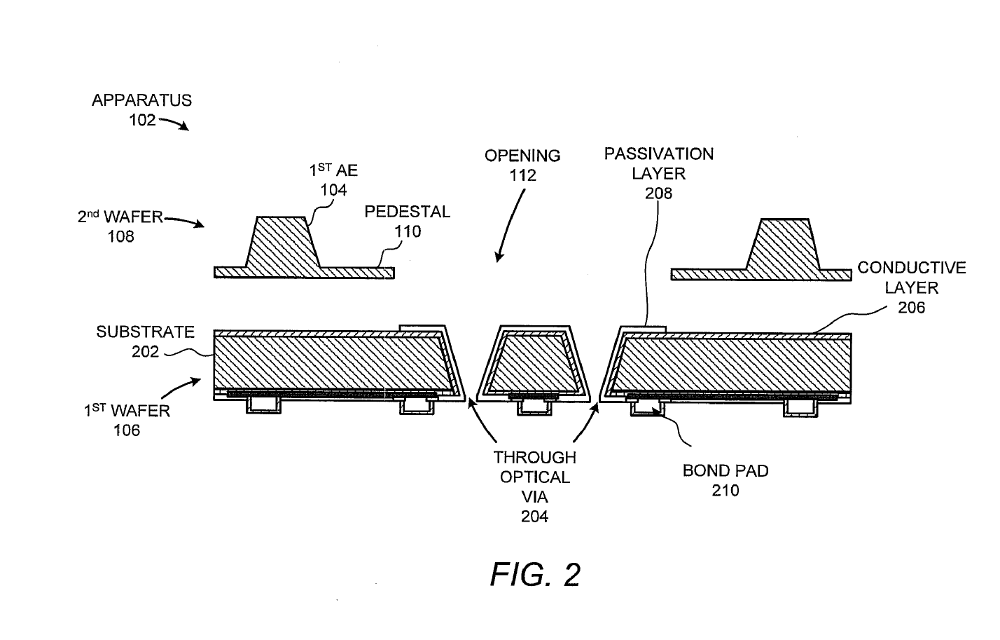

The apparatus 102 is depicted as being bonded to the OE component 120 through a plurality of solder bumps 150, which may broadly be interpreted as small amounts of solder that may be formed into any practical shape, such as a ball or a pillar. More particularly, a plurality of bond pads (210, FIG. 2) are placed on the first wafer 106 such that a second set of bond pads (not shown) on the OE component 120 precisely align with the plurality of bond pads 210. As discussed in greater detail herein below, the OE component 120 may be self-aligned with the first wafer 102 through use of the bond pads and the solder bumps 150. The alignment of the bond pads 210 on the first wafer 106 and the bond pads on the OE component 120 enables the optical elements 122 on the OE component 120 to also be aligned with through optical vias (TOVs) (204, FIG. 2) in the first wafer 106. According to an example, the OE component 120 is flip chip bonded to the apparatus 102, which refers to a process in which semiconductor devices are electronically connected.

This flip-chip process includes placing an electrical trace and under bump metals on a surface of the OE component 120 and on the surface of the first wafer 106, and then placing an accumulation of solder on the under bump metals on the surface of the OE component 120, first wafer 106, or OE component 120 and the first wafer 106. The process includes turning the first wafer 106 over, aligning the solder with the electrical traces and under bump metal of the OE component 120, and melting and solidifying the solder bumps to complete the connection. The electrical traces may be precisely fabricated on the first wafer 106 and the OE component 120 through various processes including, but not limited to photolithography.

An example process in which the OE component 120 may be bonded to the first wafer 106 to precisely self-align the optical elements 122 with the through optical vias 204 in the first wafer 106 will now be described. In the example process, the solder bumps 150 on the OE component 120 are placed in contact with the bond pads 210 on the first wafer 106. At this point, the solder bumps 150 and the bond pads 210 are not yet completely melted. Rather they are in a state so as to stick to each other. Initially, when the OE component 120 is placed near the first wafer 106 so that the solder bumps 150 come into contact with the bond pads 210, the optical elements 122 may not quite be aligned with the TOVs 204. Alternatively, the solder bumps 150 and bond pads 210 may be on the first wafer 106, and the OE component 120, respectively.

With the application of the appropriate amount of heat, the solder bumps 150 will completely melt. The size, shape, and material of the bond pads 210 and the size, shape, and material of the solder bumps 150 is such that the surface tension will bring the bond pads 210 into alignment, for instance, with bond pads (not shown) on the OE component 120. In one example, the solder bumps may be approximately 100 micrometers (pm) in diameter.

After the heat is no longer being applied, the melted solder bump 150 material will cool and solidify. This will hold the OE component 120 in place, so that the optical elements 122 are properly aligned with the TOVs 204 in the first wafer 106. Thus, when the optical elements 122 emit or detect light, that light will be appropriately directed into or received from the TOVs 204.

The apparatus 102 may be mated with the optical transmission medium 130 by substantially aligning the optical transmission medium 130 with respect to the apparatus 102 and by moving one or both of the optical transmission medium 130 and the apparatus 102 such that they approach each other. When the optical transmission medium 130 and the apparatus 102 are sufficiently close to each other, the first alignment element 104 on the apparatus 102 is to mate with the mating alignment element 136 on the optical transmission medium 130. As shown in FIG. 1, the first alignment element 104 has been depicted as having a base that is relatively wider than a top of the first alignment element 104. Likewise, the mating alignment element 136 has been depicted as having a tapered cross section. As such, the first alignment element 104 may relatively easily mate with the mating alignment element 136. In addition, the apparatus 102 may be fixedly or removably attached to the optical transmission medium 130 through any suitable attachment mechanisms, such as, friction fitting, adhesives, bonding, latching, etc. The shapes of the mating elements may be selected to initially provide coarse alignment and finally provide fine alignment in all axes.

The apparatus 102 is further depicted as being bonded to interposers 154, which may comprise printed circuit boards (PCBs), flexible boards, etc., through a plurality of solder bumps 150. In this regard, the OE system 100 may be implemented as part of an array of OE systems 100.

Turning now to FIG. 2, there is shown a partially exploded cross-sectional side view of the apparatus 102 for use in the OE system 100, according to an example. As shown therein, the first alignment element 104 may be formed in a second wafer 108, which may be made of glass, plastic, metal, a semiconductor material such as silicon, etc. In addition, the first alignment element 104 has been depicted as being formed on an optional pedestal 110. In any regard, the second wafer 108 may include an opening 112 to enable light beams to be propagated unimpeded through the second wafer 108. Alternatively, the opening 112 may be replaced with an at least partially transparent cover (not shown) that substantially seals the TOV 204. The optical properties of the cover may include, but are not limited to, optically transparent, antireflective, at least partially absorbing, and light scattering.

The first alignment element 104 may be formed through various fabrication processes, including, for instance, photolithography. The first alignment element 104, for instance, if made of photoresist, may be covered with a metallic cap (not shown) to add strength and stability to the first alignment element 104. The metallic cap may be formed by, for example, ebeam evaporation, sputtering, electroplating, etc. As another example, the first alignment element 104 is made of a semiconductor material, such as silicon. In this example, the silicon may be wafer-bonded to the first wafer 106. Because of the manufacturing techniques involved, the first alignment element 104 made of silicon may be constructed to increased dimensions to generally improve the alignment properties of the first alignment element 104. Various other examples with respect to the first alignment element 104 are described in greater detail herein below.

Because the first alignment element 104 may be constructed out of photoresist or silicon, construction is relatively simple and inexpensive. Such construction allows for alignment elements with simple and complex shapes to be fabricated at the wafer scale. This reduces the time and cost involved in manufacturing the apparatus 102 and similarly reduces the cost of optoelectronic communication.

As also shown in FIG. 2, the first wafer 106 is depicted as including a substrate 202, TOVs 204, a conductive layer 206, a passivation layer 208, and bond pads 210. The conductive layer 206 may comprise any suitable conductive material, such as, gold. The passivation layer 208 may comprise, for instance, SiN or equivalent material. The substrate 202 may be made of glass, plastic, metal, a semiconductor material such as silicon, etc. The TOVs 204 generally refer to holes formed in the first wafer 106 that are to allow light to propagate through, for instance, by bouncing off of the walls of the holes. The TOVs 204 may comprise circular cross-sections and generally operate as optical waveguides through the substrate 202. An optical waveguide and a physical structure that provides for the propagation of electromagnetic radiation through the structure at a relatively high frequency. At this frequency, light may be propagated through a first dielectric material surrounded by a second dielectric material if the second material has a lower index of refraction than the first material.

According to an example, an optically transparent filler (not shown) is positioned within the TOVs 204. The optically transparent filler generally adds strength to the apparatus 102 and prevents dust and debris from contaminating the optical elements 122. The optically transparent filler may be formed of a material that substantially does not interfere with the optical transfer of information to and/or or from the optical elements 122. Alternatively, the optically transparent material may also be used to fill the TOVs 204 and bond the first wafer 106 to the second wafer 108.

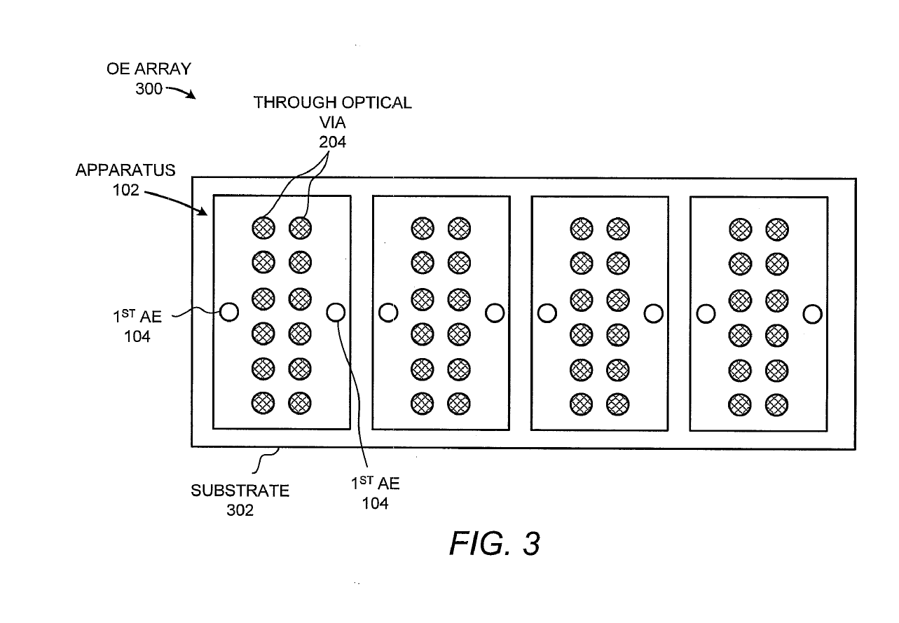

Turning now to FIG. 3, there is shown a top view of an optoelectronic (OE) array 300 of a plurality of apparatuses 102 depicted in FIGS. 1 and 2, according to an example. Although four apparatuses 102, each including twelve TOVs 204 and two first alignment elements 104, have been depicted in FIG. 3, it should be understood that the OE array 300 may include any reasonable number of TOVs 204 and first alignment elements 104 without departing from a scope of the apparatus 102 and OE system 100 disclosed herein. In addition, the apparatus 102 may comprise other shapes, such as, round, square, etc., and the TOVs 204 may be positioned in any suitable arrangement. Moreover, the first alignment elements 104 may be positioned on the apparatus 102 in any suitable arrangement.

As shown in FIG. 3, the OE array 300 includes a substrate 302 on which a plurality of apparatuses 102 are positioned. The substrate 302 may comprise the interposer 154 depicted in FIG. 1. In addition, OE components 120 may be positioned below each of the apparatuses 102 such that the optical elements 122 of the OE components 120 are positioned beneath the TOVs 204 as discussed above with respect to FIGS. 1 and 2. Moreover, optical transmission media 130 may be positioned on top surfaces of the apparatuses 102 with the mating alignment elements 136 of the optical media 130 mating with the first alignment elements 104 of the apparatuses 102. As discussed herein, the optical fibers 134 are to be passively aligned with the optical elements 122 when the mating alignment elements 136 of the optical media 130 mate with the first alignment elements 104 of the apparatus 102, as also shown in FIG. 1.

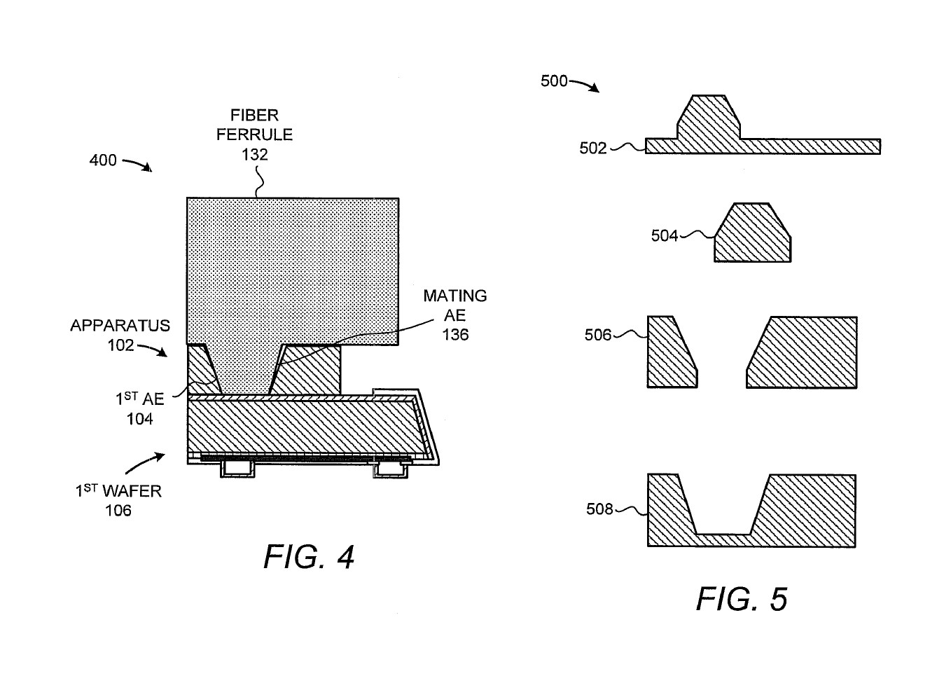

Although the first alignment elements 104 have been depicted as comprising pillars and the mating alignment elements 136 have been depicted as comprising holes, it should be understood that the first alignment elements 104 and the mating alignment elements 136 may comprise various other configurations without departing from a scope of the apparatus 102 disclosed herein. An example of a portion 400 of the OE system 100 containing a differently configured first alignment element 104 and mating alignment element 136 is depicted in FIG. 4. As shown therein, the first alignment element 104 is depicted as a hole and the mating alignment element 136 is depicted as a pillar.

Although the first alignment element 104 is depicted as having a hole that extends the entire height of the first alignment element 104, the hole may extend less than the entire height of the first alignment element 104, such that a portion of the first alignment element 104 is provided between the mating alignment element 136 and the first wafer 106. In addition, the first alignment element 104 may comprise other shapes as shown. Various examples of different shapes 502-508 of the first alignment element 104 are depicted in the diagram 500 in FIG. 5. The fiber ferrule 132 may comprise a mating alignment element 136 that is shaped to mate with the first alignment elements 104.

The first alignment element 104 may comprise other physical characteristics. For instance, sharp corners of the first alignment element 104 may be smoothed through, for instance, thermally oxidizing and wet etching the first alignment element 104. As another example, the first alignment element 104 may be oxidized or coated with a metal to form a relatively hard, for instance, non-chipping, surface. As a further example, the first alignment element 104 may be coated with Teflon™ or similar low friction coating to facilitate mating with a mating alignment element 136. As another example, the first alignment element 104 may comprise electroplated metal to form a relatively robust surface.

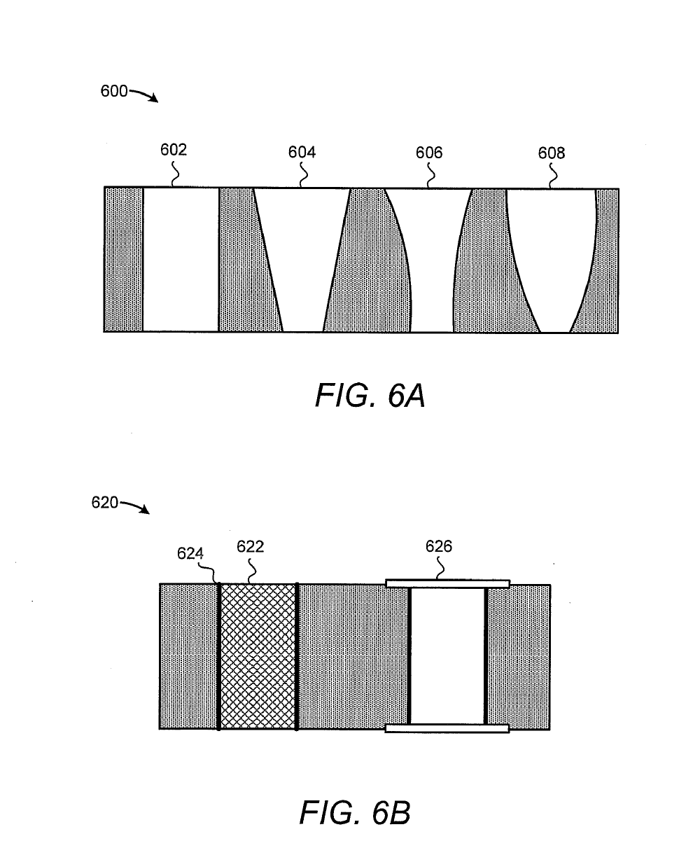

Turning now to FIG. 6A, there is shown a diagram 600 depicting TOVs of four different shapes, according to an example. Any of the TOVs depicted in FIG. 6A may replace the TOVs 204 depicted in FIG. 2.

The diagram 600 depicts a straight TOV 602, an expanding TOV 604, a parabolic expanding TOV 606, and a parabolic contracting TOV 608. The cross-sectional shape of a TOV may be circular, elliptical, rectangular, or any polygonal shape.

With reference to FIG. 6B, there is shown a diagram 620 illustrating TOVs constructed of different materials, according to an example. The TOVs depicted in FIG. 6B may replace the TOVs 204 depicted in FIG. 2.

As mentioned above, waveguides designed to propagate electromagnetic radiation within typical optical frequencies may be done through use of an inner transparent dielectric material surrounded by an outer material having a higher index of refraction then the inner material. The materials used as the inner and outer materials will affect the difference in the index of refraction between the two materials and thus the manner in which the light propagates through the waveguide.

In one example, a solid transparent dielectric material 622 may be used to form the center of the TOV 204. Either a dielectric material with a lower index of refraction than the transparent material 622 or a reflective material may be used as a lining 624 at the walls of the TOV. The reflective material may be a metallic material such as copper, gold, aluminum, silver, etc. Furthermore, a dielectric layer may be placed over the reflective layer to protect it from oxidation. In some cases, the dielectric layer serves as the transparent dielectric material 622.

In one example, the center of the TOV 204 may be either a vacuum or be filled with air, or inert gases. The walls of such a TOV may be coated with a material having a relatively high reflectivity. This allows the light to propagate through the TOV through successive reflections. The number of bounces is small because the TOV is relatively short. The TOV may only have a length of a few hundred microns. Additionally, a transparent covering 626, such as a dry film may be used to cover the center of the TOV. This will prevent contaminants from entering the center of the TOV.

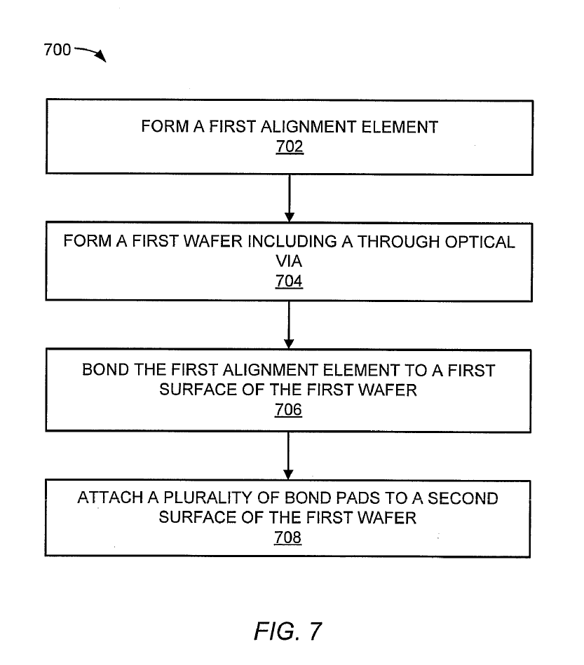

Turning now to FIG. 7, there is shown a flow diagram of a method 700 for fabricating an apparatus to passively align an optical element 122 in an OE component 120 to an optical transmission medium 130, according to an example. It should be understood that the method 700 depicted in FIG. 7 may include additional processes and that some of the processes described herein may be removed and/or modified without departing from a scope of the method 700.

At block 702, a first alignment element 104 is formed. The first alignment element 104 may be formed through any of a plurality of fabrication techniques, including forming the first alignment element 104 as part of a second wafer 108. For instance, the first alignment element 104 may be formed through at least one of photolithography, deep reactive ion etching, electroplating, etc. Photolithography is a process whereby portions of a substrate are covered by a mask so that portions not covered by the mask may be removed by deep reactive ion etching.

As another example, the first alignment element 104 through a fabrication operation selected from a group of fabrication operations consisting of electroplating a post, forming a hole through a block of material, such as SU-8, etc. The first alignment element 104 may also be formed through application of additional operations, such as, thermal oxidization and wet etch to smooth out sharp corners, oxidation or coating with materials to at least one of increase the rigidity of and reduce friction on the first alignment element 104, etc.

As a further example, a plurality of first alignment elements 104 may be formed at block 702. In this example, the plurality of first alignment elements 104 may be positioned at various locations with respect to each other. In addition, the plurality of first alignment elements 104 may comprise the same shapes or may have different shapes with respect to each other. In this regard, for instance, one of the first alignment elements 104 may comprise a pillar and another one of the first alignment elements 104 may comprise a hole.

At block 704, a first wafer 106 including a TOV 204 is formed. As discussed above, the first wafer 106 includes a substrate 202, which may be made of glass, plastic, metal, a semiconductor material such as silicon, etc. In addition, the TOV 204 may be formed into the substrate 202 through any suitable process to form an opening in the substrate 202. In addition, the substrate 202 may be patterned with metal traces, under bump metals, solder bumps, etc., to form the first wafer 106, as shown in FIGS. 1 and 2.

At block 706, the first alignment element 104 is bonded to a first surface of the first wafer 106, such that the TOV 204 is uncovered by the first alignment element 104. According to an example, the first alignment element 104 is wafer bonded to the first wafer 106. The term “wafer bond” refers to manufacturing processes that are used to bond thin substrates of similar or dissimilar material to one another. More particularly, the first alignment element 104 is bonded to the first wafer 106 through, for instance, low temperature metal to metal thermocompression bonding, eutectic bonding, adhesive bonding, anodic bonding, fusion bonding, etc. According to a particular example, the first alignment element 104 is formed of silicon and is bonded to the first wafer 106 through a gold-silicon bonding operation. Accordingly to another example, the first alignment element 104 includes a gold layer and is boded to the first wafer 106 through a gold-gold bonding operation. During the bonding operation, the plurality of first alignment elements 104 and TOVs 204 are precisely aligned.

At block 708, a plurality of bond pads 210 are attached to a second surface of the first wafer 106. The bond pads 210 may be formed on the first wafer 106 through any suitable process, such as, photolithography and metallization. In addition, the bond pads 210 may be formed at particular sites on the second surface of the first wafer 106 to cause the optical elements 122 to be precisely aligned with the through optical vias 204 when the OE component 120 is attached to the bond pads 210, as discussed in greater detail herein above.

According to an example, TOVs 204 are formed in the first wafer 106 through photolithography, in which, a mask is used to expose the locations where the TOVs 204 are to be formed through an etching process. Another mask may then be used to form the locations of the bond pads 210. These masks can be properly aligned so that the TOVs 204 are appropriately spaced in relation to the bond pads 210. This appropriate spacing, which corresponds to the bond pad spacing on the OE component 120, allows for proper alignment of the optical elements 122 to the TOVs 204. This photolithographic process may be performed on a wafer level. For example, if the substrate 202 is a semiconductor material, then the photolithographic process may be applied to the entire semiconductor wafer.

Following fabrication of the apparatus 102, the OE component 120 may be attached to the bond pads 210 and the optical transmission medium 130 may be connected to the first alignment element 104, as discussed above. For instance, the OE component 120 may be flip-chip bonded to the apparatus 102 in a manner that the OE component 120 is self-aligned with the through optical vias 204 in the apparatus 102. As also discussed above, the optical elements 122 on the OE component 120 may relatively easily be aligned with the TOVs 204 and the optical transmission medium 130 may passively be aligned with the TOVs 204 through mating of the first alignment element 104 and the mating alignment element 136.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An apparatus for use in optoelectronics, said apparatus comprising:
a first alignment element; and
a first wafer comprising a through optical via, wherein the first alignment element is bonded to the first wafer, such that the through optical via is uncovered by the first alignment element, wherein the first wafer further comprises a plurality of bond pads upon which an optoelectronic component having an optical element is to be attached, wherein the first alignment element is to mate with a mating alignment element on an optical transmission medium, and wherein the optical transmission medium is to be passively aligned with the optical element through the through optical via when the first alignment element mated with the mating alignment element on the optical transmission medium.

2. The apparatus according to claim 1, further comprising:
a second wafer, wherein the second wafer comprises the first alignment element, wherein the second wafer is bonded to the first wafer, and wherein the second wafer comprises an opening or an at least partially transparent cover over the through optical via.

3. The apparatus according to claim 1, wherein the second wafer comprises a second alignment element, wherein the second alignment element is to mate with a second mating alignment element on the optical transmission medium.

4. The apparatus according to claim 1, wherein the first alignment element comprises a relatively rigid layer to interface with the mating alignment element on the optical transmission medium.

5. The apparatus according to claim 1, wherein the plurality of bond pads are positioned at predetermined and aligned locations with respect to the through optical via.

6. The apparatus according to claim 1, further comprising:
an optically transparent filler positioned within the through optical via.

7. A method for fabricating an apparatus to passively align an optical element in an optoelectronic component to an optical transmission medium, said method comprising:
forming a first alignment element;
forming a first wafer including a through optical via;
bonding the first alignment element to a first surface of the first wafer such that the through optical via is uncovered by the first alignment element;
attaching a plurality of bond pads on a second surface of the first wafer, opposite the first surface, wherein the plurality of bond pads are to attach to an optoelectronic component having an optical element; and
wherein the first alignment element is to mate with a mating alignment element on an optical transmission medium, and wherein the optical transmission medium is to be passively aligned with the optical element when the first alignment element is mated with the mating alignment element on the optical transmission medium.

8. The method according to claim 7, wherein forming the first wafer further comprises forming the first wafer to include electrical traces.

9. The method according to claim 7, wherein forming the first alignment element further comprises forming the first alignment element through a forming technique selected from the group consisting of photolithography, deep reactive ion etching, and electroplating.

10. The method according to claim 7, further comprising:
forming a second wafer, wherein forming the first alignment element further comprises forming the first alignment element into the second wafer; and
wherein bonding the first alignment element to the first wafer further comprises bonding the second wafer to the first wafer.

11. The method according to claim 10, wherein bonding the second wafer to the first wafer further comprises bonding the second wafer to the first wafer using a bonding operation selected from a group of bonding operations consisting of low temperature metal to metal thermocompression bonding, eutectic bonding, adhesive bonding, anodic bonding, and fusion bonding.

12. The method according to claim 7, wherein forming the plurality of bond pads on the second surface of the first wafer further comprises aligning the plurality of bond pads with respect to the through optical via to cause the optical element in the optoelectronic component to be precisely aligned with the through optical via when the optoelectronic component is attached to the plurality of bond pads.

13. The method according to claim 7, wherein forming the first alignment element further comprises forming the first alignment element through a fabrication operation selected from a group of fabrication operations consisting of electroplating a post and forming a hole through a block of material.

14. An optoelectronic system comprising:
an apparatus having,
a first wafer having a through optical via and a plurality of bond pads attached to a first surface of the first wafer;
a first alignment element bonded to a second surface of the first wafer such that the through optical via is uncovered by the first alignment element; and
an optoelectronic component attached to the plurality of bond pads, wherein the first alignment element is to mate with a mating alignment element on an optical transmission medium, and wherein the optical transmission medium is to be passively aligned with an optical element of the optoelectronic component through the through optical via when the first alignment element is mated with the mating alignment element on the optical transmission medium.

15. The optoelectronic system according to claim 14, further comprising:
a second wafer, wherein the second wafer comprises the first alignment element, wherein the second wafer is bonded to the first wafer, and wherein the second wafer comprises an opening over the through optical via.
